(19) United States
(12) Patent Application Publication
(10) Pub. No.: US 2006/0227136 A1
(43) Pub. Date: Oct. 12, 2006

(54) Method for representing preoperatively recorded three-dimensional image data when recording two-dimensional X-ray images

(75) Inventors: Jan Boese, Eckental (DE); Norbert Rahn, Forchheim (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/398,883

(22) Filed: Apr. 6, 2006

(30) Foreign Application Priority Data
Apr. 8, 2005 (DE) 10 2005 016 256.8

(51) Int. Cl. G06T 17/00

(52) U.S. Cl. 345/424

(57) ABSTRACT

In a method for representing preoperatively recorded three-dimentional image data when recording two-dimentional X-ray images, parameters for recording the two-dimentional X-ray images are placed in relation to two-dimentional representations of the three-dimentional image data and coupled thereto. When paraneters for recording the two-dimentional X-ray images change, corresponding two-dimentional representations of the three-dimentional image data are shown on a screen.

### CROSS REFERENCE TO RELATED APPLICATIONS

This application claims priority to the German Application No. 10 2005 016 256.8, filed Apr. 8, 2005 which is incorporated by reference herein in its entirety.

### FIELD OF INVENTION

The invention relates to a method for representing preoperatively recorded three-dimensional image data when recording two-dimensional X-ray images as well as to an X-ray image recording system.

### BACKGROUND OF INVENTION

Before an operation is performed, i.e. preoperatively, three-dimensional image data is often recorded for the purpose of carrying out an initial diagnosis, for example CT image data or NMR image data.

During an operation a physician now frequently records two-dimensional X-ray images in order, for example, to guide catheters precisely or to set incisions precisely etc. In such a scenario the physician first looks at the three-dimensional image data in different representations (“views”) and has these, as it were, “in his head”. Previously there was no possibility available to him of retrieving the three-dimensional image data during the operation and placing it in relation to the recorded X-ray images.

### SUMMARY OF INVENTION

It is known from U.S. Pat. No. 6,198,790 to use both a conventional X-ray technique (radiography) and a tomographic X-ray technique (computed topography, CT) for the medical diagnosis within a system. In this approach, however, the three-dimensional image data is recorded at the same frame structure. The present invention is suitable for applications not only in such systems in which the three-dimensional image data has been acquired using the same structure, but also in particular when three-dimensional image data has been captured preoperatively with the aid of a quite different structure.

It is known from U.S. Pat. No. 5,954,650 A to generate three-dimensional image data using two different techniques (CT and NMR) and to arrange two-dimensional representations of the data record not only side by side in each case, but also to achieve a fusion of the images. In the course of the fusion the alignment of the images with one another must naturally be coordinated.

An object of the invention is to provide an improved method for representing preoperatively recorded three-dimensional image data when recording two-dimensional X-ray images, which method provides the physician with more unequivocal support during an operation than in the prior art.

The object is achieved by the claims.

The result obtained by the method according to the invention is that repeatedly when parameters change in the controller for recording the two-dimensional X-ray images corresponding two-dimensional representations of the three-dimensional image data are generated by the image processing system and shown on a screen.

The two-dimensional X-ray images are thus placed in relation to the preoperatively recorded three-dimensional image data, and moreover the coupling is preferably such that the two-dimensional representations correspond to the two-dimensional X-ray images, i.e. that the perspective is chosen analogously.

By this means it is possible for a two-dimensional image to be obtained from the three-dimensional image data, which two-dimensional image shows the same view as the X-ray image. The two-dimensional representation is preferably displayed before an X-ray image is recorded so that the physician can choose whether he needs an X-ray image for this view.

As a result of his previous diagnosis the physician can now selectively modify the parameters for recording the two-dimensional X-ray images and have a corresponding two-dimensional representation of the three-dimensional image data displayed in each case. Only then does he choose whether he would like a corresponding X-ray image. In this way the recording of the X-ray images is optimized, the X-ray images are used to optimal effect and the overall X-ray image dose can be reduced.

In a preferred embodiment the two-dimensional X-ray images are placed in relation to the two-dimensional representations of the three-dimensional image data interactively by the user. For example, the user can initially have a two-dimensional X-ray image recorded with specific parameters displayed and then have the three-dimensional image data displayed in an associated manner. These two-dimensional views can now be rotated in the three-dimensional frame until the two-dimensional view is adjusted to the X-ray image and subsequently the user can input that the three-dimensional image data is now to be coupled with the specific parameters of the X-ray image so that a coordinate system in the image data can be placed in relation to a coordinate system of the X-ray system. The user can make fine adjustments if necessary.

The parameters include, for example, angle settings of an X-ray C-arm of an X-ray angiography system or a biplane C-arm system. If the user then changes the angle settings of the X-ray C-arm during the operation, the two-dimensional representation of the three-dimensional image data rotates during this change until there appears on the screen a view corresponding to an X-ray image that could be recorded at the present time.

It should be pointed out once again that in a preferred embodiment the changed two-dimensional representation of the three-dimensional image data is already displayed on the screen before an associated X-ray image is recorded, i.e. it supports the physician in choosing suitable perspectives for X-ray images, the physician being able to compare the preoperatively recorded data with the currently intraoperatively recorded data at any time.

As an alternative to the two-dimensional X-ray images being placed in relation to the two-dimensional representations of the three-dimensional image data interactively, the process can also take place automatically. The three-dimensional image data must then be registered by an-image processing system and the image processing system then executes an algorithm in which it calls up different perspectives of this three-dimensional image data and compares each with an X-ray image. The image processing system then uses a similarity measure with the two-dimensional X-ray image in order to define the coupling. Following a rotation of the two-dimensional representations the coupling takes place when the similarity measure is at a maximum. The prior art provides various techniques for this purpose.

The invention also relates to an X-ray image recording system having a controller for adopting a position of image-generating device parts for recording at least one two-dimensional image and having an image processing system which can process three-dimensional image data from other diagnostic equipment. With the invention there is a coupling between controller and processing system such that the image processing system can represent a two-dimensional image generated from the three-dimensional image data as a function of the adopted position.

The image processing system can be provided separately from the actual X-ray image recording system and be connected to the latter for example via a cable via which the controller transmits corresponding parameters relating to the position of the image-generating device parts to the image processing system so that these can be coupled with a coordinate system of three-dimensional image data.

If the X-ray image recording system is an X-ray angiography system, then in any case there are usually image processing systems available which can process three-dimensional image data from the X-ray angiography. Preferably it is then such that this image processing system is expanded in such a way that it is also capable of processing preoperatively recorded three-dimensional image data.

The X-ray angiography system has a C-arm, and the image processing system is accordingly supplied with data relating to the angle settings of the C-arm.

Alternatively the X-ray image recording system can comprise a biplane C-arm system. The image processing system is then coupled to only one controller for imaging in one of two planes or optionally to two controllers for imaging in two different planes.

Since, in a preferred alternative of the invention, the three-dimensional image data is adjusted relative to an X-ray image recorded in a specific position, the image processing system preferably comprises an input means for performing such an adjustment and to enable the input that the different data is to be connected.

If, in accordance with the abovementioned alternative possibility, the three-dimensional image data is to be adjusted automatically to the two-dimensional image with the aid of a similarity measure, the image processing system must be capable of placing the spatial orientation of the three-dimensional image data in relation to an X-ray image recorded in a specific position on the basis of a similarity measure.

### BRIEF DESCRIPTION OF THE DRAWINGS

A preferred embodiment of the invention will now be described with reference to the drawings, in which:

FIG. 1 illustrates the synchronized rotation of preoperatively recorded 3D images with the C-arm angulation of an X-ray angiography system, and

FIG. 2 illustrates the synchronized rotation of endoscope-type representations of preoperatively recorded 3D images with the C-arm angulation of an X-ray angiography system.

### DETAILED DESCRIPTION OF INVENTION

Preoperatively recorded three-dimensional image data is used during an operation to assist in the recording of two-dimensional X-ray images.

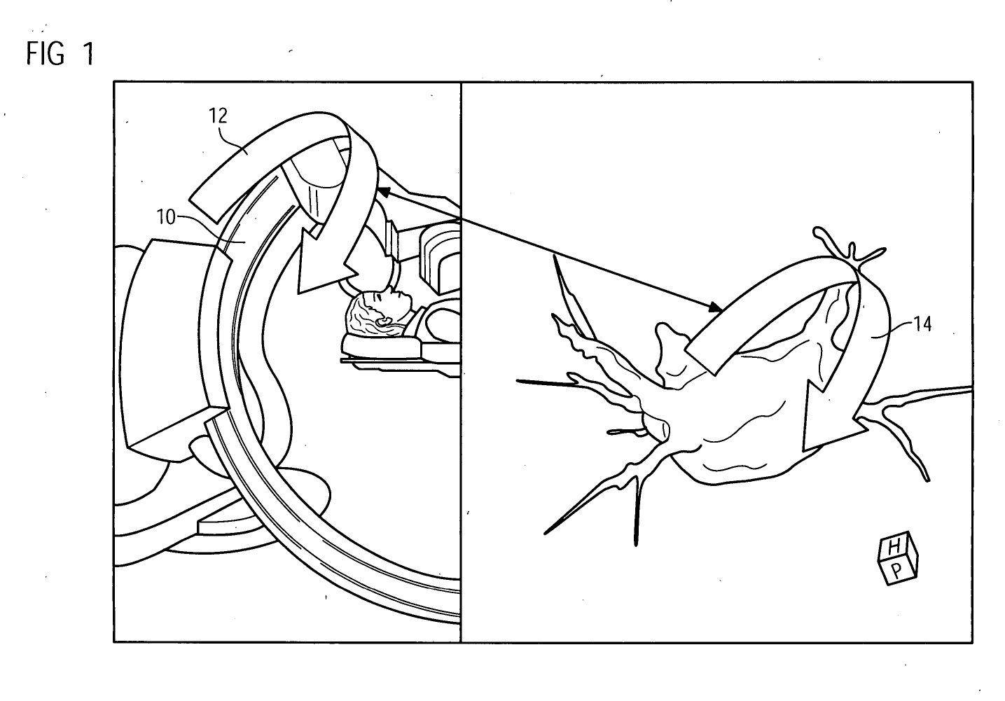

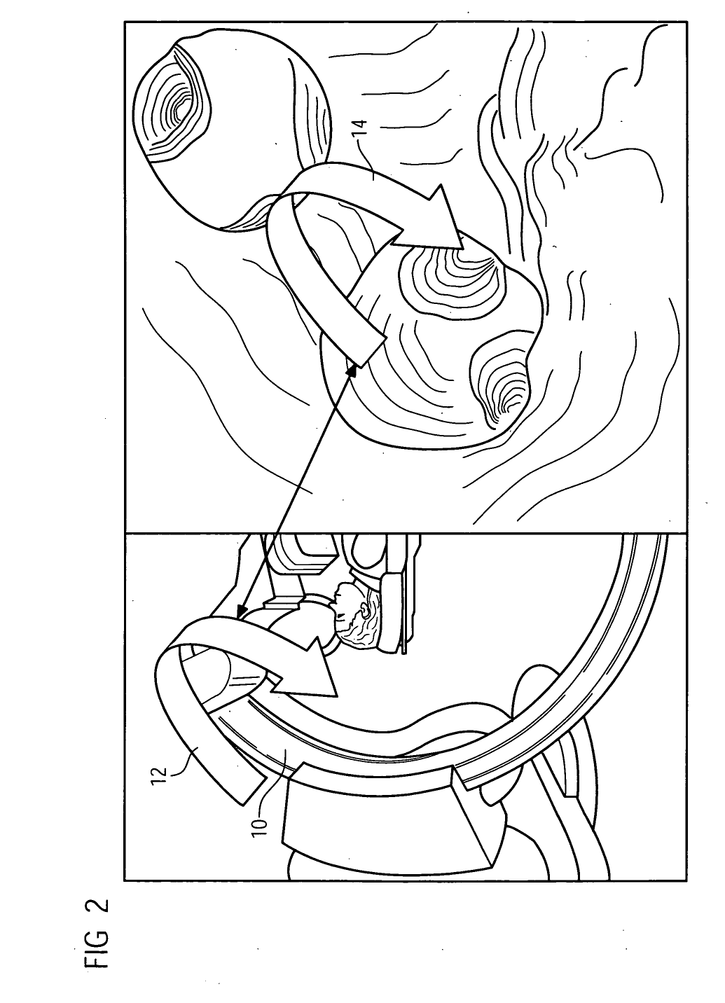

Examples of preoperatively recorded image data are shown on the right of the picture in each case in FIGS. 1 and 2.

Three-dimensional image data can be represented two-dimensionally as follows: In perspective, in cross-section or in an endoscope-type representation (“endoscopic view”), as shown in FIG. 2. The physician treating the patient can choose a suitable representation depending on the requirements that the treatment of the patient entails.

At the start of the treatment the treating physician thus places the three-dimensional image data in relation to the settings of an X-ray C-arm (referenced in the drawing by the numeral 10) of an X-ray angiography system or of a biplane C-arm system.

The treating physician first performs a rough adjustment, followed by a fine adjustment. During the rough adjustment the treating physician will take into account that he knows or can deduce the recording conditions for generating the three-dimensional image data. For the angulation of the X-ray C-arm 10 he chooses a setting in which the recorded X-ray image corresponds to a specific two-dimensional representation of the three-dimensional image data.

Next, he records a first X-ray image to which the three-dimensional image data must now be adjusted. The three-dimensional image data must now be rotated until it corresponds to the recorded X-ray image. With a sectional image this means that it must essentially become congruent with the X-ray image, with a perspective view the perspective must be the same as that which led to the production of the X-ray image, and with an endoscopic view the topmost imaging plane likewise corresponds to a sectional image.

It is now essential that the user can rotate the three-dimensional image data in its two-dimensional representation via a suitable tool, for example a computer mouse, until it matches the X-ray image shown on another screen or shown in a different section on the same screen. (In each case FIGS. 1 and 2 show only the two-dimensional representation of the three-dimensional image data.)

Once the physician, which is to say the user, has achieved a match, he inputs via a mouse button or keyboard that he would now like to couple the three-dimensional image data with the two-dimensional X-ray images. This means that the parameters of the corresponding two-dimensional representation are placed in relation to the parameters for recording the X-ray image; for example, a specific display angle can be placed in relation to the angulation angle of the X-ray C-arm 10.

The three-dimensional image data is now to present to the treating physician the preoperative image data such that it is coupled to the respective settings of the X-ray system. This means that when the X-ray C-arm rotates, the corresponding representation of the two-dimensional image data also rotates. This is indicated in the figures by the fact that the arrow 12, which illustrates the rotation of the image-generating parts on the X-ray C-arm, is here placed in relation to the arrow 14, which illustrates the rotation of the two-dimensional representation of the three-dimensional image data. If the treating physician now records a further X-ray image, this means that this X-ray image is automatically congruent with the currently displayed three-dimensional image data. Accordingly the three-dimensional image data helps the treating physician during the operation in choosing suitable X-ray C-arm settings. It can be provided for example that for the removal of body tissue the preoperatively recorded image data showing the not yet removed body tissue is shown, and that during the removal of the body tissue X-ray images are constantly recorded which in a tailored manner image parts of the body in which the tissue has not yet been removed.

The invention enables the treating physician to place the preoperatively recorded three-dimensional image data optimally in relation to the intraoperatively recorded X-ray images during the operation and in particular to choose the perspective of the X-ray images already in a precisely targeted manner before they are recorded.

1-12. (canceled)

13. A method of displaying preoperatively recorded three-dimensional image data while recording two-dimensional X-ray images, the method comprising:
recording a plurality of two-dimensional X-ray images using an X-ray device having recording parameters;
determining two-dimensional representations of the three-dimensional image data;
interrelating the recording parameters to the two-dimensional representations; and
displaying the two-dimensional representations while recording the two-dimensional X-ray images, wherein the two-dimensional representations are adjusted and the adjusted two-dimensional representations displayed if the recording parameters are adjusted while recording the two-dimensional X-ray images, the adjusted two-dimensional representations determined based on the interrelation between the recording parameters and the two-dimensional representations.

14. The method as claimed in claim 13, wherein interrelating the recording parameters to the two-dimensional representations is interactively performed by a user.

15. The method as claimed in claim 14, wherein
the interaction includes displaying upon a user request one of the two-dimensional X-ray images recorded under specific recording parameters,
determining the two-dimensional representations of the three-dimensional image data is based on at least one rotation of the three-dimensional image data such that the rotated three-dimensional image data correspond to a recording position of the one two-dimensional X-ray image recorded under the specific recording parameters, the rotation performed by a user, and
interrelating the recording parameters to the two-dimensional representations includes interrelating upon a further user request the specific recording parameters to the two-dimensional representations determined from the rotated three-dimensional image data.

16. The method as claimed in claim 13, wherein interrelating the recording parameters to the two-dimensional representations is performed automatically using an algorithm based on a mathematical similarity measure.

17. The method as claimed in claim 13, wherein the recording parameters comprise angle settings of a C-arm of an X-ray angiography system or of a biplane C-arm system.

18. The method as claimed in claim 13, wherein the adjusted two-dimensional representations are displayed before recording a two-dimensional X-ray image using the adjusted recording parameters.

19. An X-ray imaging system, comprising:
a controller for adjusting a position of image-generating device parts, the device parts provided for recording at least one two-dimensional image at the position; and
an image processing system for processing three-dimensional image data originating and fed to the X-ray imaging system from an external diagnostic device and for generating two-dimensional representations of the three-dimensional image data, wherein the controller and the image processing system are connected such that the two-dimensional representations are displayed relative to the position of the image-generating device parts.

20. The X-ray imaging system as claimed in claim 19, further comprising an input device configured to:
adjust the three-dimensional image data by rotating the three-dimensional image data such that the adjusted three-dimensional image data correspond to an X-ray image recorded at a specific position; and
interrelate the adjusted three-dimensional image data to the X-ray image recorded at the specific position.

21. The X-ray imaging system as claimed in claim 20, wherein adjusting the three-dimensional image data by rotating the three-dimensional image data includes determining a spatial orientation of the three-dimensional image data relative to a the X-ray image recorded at the specific position, by the image processing system using an algorithm based on a mathematical similarity measure.

22. The X-ray imaging system as claimed in claim 19, wherein
the X-ray imaging system includes an X-ray angiography system,
the image-generating device parts comprise a C-arm of the X-ray angiography system, and
the controller transmits position data regarding an angle settings of the C-arm to the image processing system.

23. The X-ray imaging system as claimed in claim 19, wherein
the X-ray imaging system is a biplane C-arm system,
the controller comprises first and second controller units for controlling a first respectively second imaging plane of the biplane C-arm system, and
the image processing system is connected to only one of the controller units.

24. The X-ray imaging system as claimed in claim 19, wherein
the X-ray imaging system is a biplane C-arm system,
the controller comprises first and second controller units for controlling a first respectively second imaging plane of the biplane C-arm system, and
the image processing system is connected to both the first and second controller units.
